(19) United States
(12) Patent Application Publication
(10) Pub. No.: US 2009/0188054 A1
(43) Pub. Date: Jul. 30, 2009

(54) Aqueous polymer dispersions containing alkenyl succinic acid anhydrides, methods for the production thereof, and use of the same

(75) Inventors: Rainer Dyllick-Brenzinger, Speyer (DE); Reinhold J. Leyrer, Dannstadt-Schauernheim (DE); Andreas Brockmeyer, Bickenbach (DE); Markus Schmid, Deidesheim (DE); Roland Ettl, Ketsch (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/585,339

(22) PCT Filed: Jan. 14, 2005
(86) PCT No.: PCT/EP2005/000308

§ 371 Date: Jul. 6, 2006

(30) Foreign Application Priority Data
Jan. 21, 2004 (DE) 102004003261.0

(51) Int. Cl. C08F 220/40; D06M 15/51

(52) U.S. Cl. 8/115.6; 524/824

(57) ABSTRACT

Aqueous alkenylsuccinic anhydride-containing polymer dispersions which are obtainable by miniemulsion polymerization of hydrophobic monoethylenically unsaturated monomers in the presence of alkenylsuccinic anhydrides, processes for the preparation of such polymer dispersions by polymerizing hydrophobic monomers by a miniemulsion polymerization method in the presence of at least one alkenylsuccinic anhydride and, if appropriate, an alkyldiketene, and use of the resulting aqueous alkenylsuccinic anhydride-containing polymer dispersions as engine and surface sizes for paper and for imparting water repellency to leather, natural and/or synthetic fibers and textiles.

The present invention relates to aqueous alkenylsuccinic anhydride-containing polymer dispersions, processes for their preparation by emulsifying alkenylsuccinic anhydrides in water in the presence of stabilizers under the action of shear forces, and the use of the resulting aqueous alkenylsuccinic anhydride-containing dispersions as sizes for paper and as water repellents for leather, natural and/or synthetic fibers and textiles.

The use of aqueous alkenylsuccinic anhydride emulsions which have been stabilized with the aid of starch as engine sizes for paper and paper products is known, cf. EP-A-0 609 879, EP-A-0 593 075 and U.S. Pat. No. 3,102,064. However, such emulsions are not storage-stable because the anhydride groups of the alkenylsuccinic anhydrides hydrolyze in the presence of water. The stability of aqueous alkenylsuccinic anhydride emulsions is dependent on a plurality of factors, for example on the purity of the anhydrides, the amount of starch used for the stabilization, the particle size of the emulsified alkenylsuccinic anhydrides, the pH of the aqueous emulsion and the temperature during the storage of the emulsions. In practice, alkenylsuccinic anhydride emulsions must therefore be used immediately after their preparation for the engine sizing of paper. An overview of the sizing with alkenylsuccinic anhydrides is given, for example, by C. E. Farley and R. B. Wasser in The Sizing of Paper, Second Edition, (3), Sizing With Alkenyl Succinic Anhydride, TAPPI PRESS, 1989, ISBN 0-89852-051-7.

The prior German Application 102 48 879.7 discloses alkyldiketene-containing aqueous polymer dispersions which are obtainable by miniemulsion polymerization of hydrophobic monoethylenically unsaturated monomers, such as styrene, acrylonitrile and/or (meth)acrylates in the presence of alkyldiketenes. In order to prepare such polymer dispersions, an organic phase which contains at least one alkyldiketene and at least one monoethylenically unsaturated hydrophobic monomer in dissolved form is first emulsified in the presence of a surfactant in an aqueous phase with the aid of mechanical emulsification apparatuses with the formation of a miniemulsion having a particle size of the emulsified organic phase of not more than 500 nm, at least one of the two phases additionally containing a free radical polymerization initiator, or a polymerization initiator being added to the miniemulsion, and the monomers of the miniemulsion are then polymerized. The particle size of the dispersed polymers and of the dispersed alkyldiketenes in these dispersions is, for example, from 50 to 500 nm, preferably from 50 to 200 nm. The resulting aqueous alkyldiketene-containing polymer dispersions are used as sizes for paper and as water repellents for leather, natural and/or synthetic fibers and textiles. The storage stability of the dispersions is in need of further improvement.

The preparation of miniemulsions is known. These are understood as meaning particularly finely divided emulsions of hydrophobic monomers in water. The particle size of the monomers emulsified in the aqueous phase is in the nanometer range, e.g. from 5 to 500 nm. In order to prepare, for example, a miniemulsion of styrene in water, ultrasound is allowed to act on a mixture of styrene, a surfactant, such as sodium dodecylsulfate, and a hydrophobic component, such as hexadecane or olive oil, for homogenization. Stable miniemulsions of styrene in water having a mean particle diameter of the emulsified styrene of, for example, from 78 to 102 nm are obtained in this manner, cf. K. Landfester, Macromol. Rapid Commun. 22 (2001), 896-936. These emulsions can ideally be polymerized to polymer latices with retention of the particle size of the emulsified monomer droplets. In the case of the miniemulsion polymerization, it is possible to incorporate water-insoluble compounds, such as alkyd resins or pigments, into the latices forming.

The prior WO 04/037867 also discloses the preparation of aqueous alkyldiketene-containing dispersions by miniemulsion polymerization of hydrophobic monoethylenically unsaturated monomers in the presence of alkyldiketenes and water-soluble or water-swellable polysaccharides. These dispersions are likewise used as sizes for paper and for imparting water repellency to leather, natural and/or synthetic fibers and textiles.

It is an object of the present invention to provide novel formulations which are based on alkenylsuccinic anhydrides and have improved stability compared with the aqueous alkenylsuccinic anhydride emulsions disclosed in the prior art.

We have found that this object is achieved, according to the invention, by aqueous alkenylsuccinic anhydride-containing polymer dispersions which are obtainable by miniemulsion polymerization of hydrophobic monoethylenically unsaturated monomers in the presence of alkenylsuccinic anhydrides.

Such polymer dispersions are obtainable, for example, by emulsifying an organic phase which contains
at least one alkenylsuccinic anhydride and
at least one monoethylenically unsaturated hydrophobic monomer
   in dissolved form, in the presence of a surfactant in an aqueous phase with the aid of mechanical emulsification methods with formation of a miniemulsion having a particle size of the emulsified organic phase of not more than 500 nm, at least one of the two phases additionally containing a free radical polymerization initiator, or a polymerization initiator being added to the miniemulsion, and polymerizing the monomers of the miniemulsion. The aqueous alkenylsuccinic anhydride-containing polymer dispersions are obtainable by polymerizing the miniemulsions described above, which, for example, are prepared by emulsifying the organic phase in the aqueous phase by the action of ultrasound or with the aid of high-pressure homogenizers.

The present invention also relates to a process for the preparation of aqueous alkenylsuccinic anhydride-containing polymer dispersions, hydrophobic monomers being polymerized by a miniemulsion polymerization method in the presence of at least one alkenylsuccinic anhydride. The miniemulsion polymerization is preferably additionally effected in the presence of at least one water-soluble and/or water-swellable polysaccharide. The preparation of the novel aqueous alkenylsuccinic anhydride-containing polymer dispersions is effected, for example, by a procedure in which an organic phase which contains
at least one alkenylsuccinic anhydride and
at least one monoethylenically unsaturated hydrophobic monomer
   in dissolved form is emulsified in the presence of a surfactant in an aqueous phase with the aid of mechanical emulsification apparatuses with formation of a miniemulsion having a particle size of the emulsified organic phase of not more than 500 nm, and the monomers of the miniemulsion are polymerized in the presence of at least one water-soluble and/or water-swellable polysaccharide and at least one polymerization initiator.

Alkenylsuccinic anhydrides are known compounds. As is evident from the literature references stated in the prior art, TAPPI PRESS 1989, EP-A-0 609 879, EP-A-0 593 075 and U.S. Pat. No. 3,102,064, aqueous emulsions of alkenylsuccinic anhydrides are used as engine sizes for paper. All alkenylsuccinic anhydrides which have been described to date for this application in the literature and have been used for this purpose in practice can be employed in the novel process for the preparation of alkenylsuccinic anhydride-containing polymer dispersions.

Alkenylsuccinic anhydrides suitable for the engine sizing of paper contain an alkylene radical of at least 6 carbon atoms, preferably a C₁₄- to C₂₄-olefin radical, in the alkenyl group. Particularly preferred alkenylsuccinic anhydrides contain 16 to 22, generally 16 to 18, carbon atoms in the alkenyl group. Alkenylsuccinic anhydrides (usually abbreviated to ASA, and also in the following text) are obtainable, for example, from α-olefins, which are first isomerized. The reaction product obtained in the isomerization—generally a mixture of various isomers—is then subjected to an ene reaction with an excess of maleic anhydride to give ASA. Examples of substituted succinic anhydrides (ASA) are decenylsuccinic anhydride, octenylsuccinic anhydride, dodecenylsuccinic anhydride and n-hexadecenylsuccinic anhydride. The individual isomeric alkenylsuccinic anhydrides may have different sizing effects. For example, 2- and 3-hexadecenylsuccinic anhydrides are not as effective as the isomeric 4-, 5-, 6-, 7- and 8-hexadecenylsuccinic anhydrides when used as engine sizes. 7-Hexadecenylsuccinic anhydride is particularly effective as a size. ASA obtained from octadecenes and maleic anhydride have an action profile similar to that of the isomeric hexadecenylsuccinic anhydrides. Of the ASA obtained from octadecene isomers, 8-octadecenylsuccinic anhydride is the most effective size, followed by the 9- and 7-octadecenylsuccinic anhydrides. Examples of further suitable ASA are the reaction products of 7-tetradecene, eicosenes and docosenes with maleic anhydride.

The miniemulsion polymerization is described in detail, for example, in the literature reference Macromol. Rapid Commun. 22, (2001), 896-936, mentioned at the outset. The important feature of this polymerization process is that an organic phase is distributed in a particularly finely divided form in an aqueous phase which contains a surfactant for stabilizing the emulsion. The mean particle diameter of the particles emulsified in the aqueous phase is, for example, from 50 to 500 nm, preferably from 50 to 200 nm, in particular from 50 to 150 nm. In the miniemulsion polymerization, the particle size of the emulsified particles ideally virtually does not change during the polymerization, so that the mean particle size of the polymers which are present in the aqueous polymer dispersions is likewise in the range stated for the emulsified organic phase. In addition to the pure miniemulsion polymerization, an emulsion polymerization is also observed in practice as a competing reaction.

Such small particle sizes of not more than 500 nm are achieved if the organic phase used for the preparation of the emulsion is emulsified with the aid of mechanical emulsification methods. Such methods are known. They are described in detail, for example, by H. Schubert et al., in Mischen und Rühren—Grundlagen und moderne Verfahren für die Praxis, VDI Conference, Nov. 23-24, 1988, Baden-Baden, under Neue Entwicklungen auf dem Gebiet der Emulgiertechnik. In the mechanical emulsification methods, the apparatuses used are, for example, high-pressure homogenizers, apparatuses generating ultrasound, microfluidizers, rotor-stator apparatuses, Taylor reactors, Cuette cells, jets, and apparatuses operating by the membrane technique. The important principle of these apparatuses is based on the fact that high shear fields are built up in them in a short time. The emulsification of the organic phase in the aqueous phase is preferably effected with the aid of apparatuses generating ultrasound or with the aid of high-pressure homogenizers.

Suitable hydrophobic monoethylenically unsaturated monomers which can be polymerized by a miniemulsion polymerization method are, for example, monomers from the group consisting of styrene, methylstyrene, C₂- to C₂₈-olefins, esters of monoethylenically unsaturated carboxylic acids of 3 to 5 carbon atoms and monohydric alcohols of 1 to 22 carbon atoms, vinyl esters of C₁- to C₁₈-carboxylic acids, acrylonitrile and methacrylonitrile. Preferably used monomers from this group are styrene, methyl methacrylate, n-butyl acrylate, isobutyl acrylate, tert-butyl acrylate and acrylonitrile or mixtures of these monomers.

For modifying the properties of the resulting minipolymer dispersions, the hydrophobic monomers can, if appropriate, be used together with small amounts of hydrophilic monomers. The hydrophilic monomers are, however, used at most in an amount such that the resulting copolymers have a solubility of not more than 10, preferably 1, g/l in water at 20° C. and a pH of 2. Suitable hydrophilic compounds belong, for example, to the group consisting of the ethylenically unsaturated carboxylic acids of 3 to 5 carbon atoms, acrylamide, methacrylamide, N-vinylformamide, N-vinylpyrrolidone, N-vinylimidazole, vinyl ethers, 2-acrylamido-2-methylpropanesulfonic acid, vinylsulfonic acid, styrenesulfonic acid, sulfopropyl acrylate, sulfopropyl methacrylate, fumaric acid, maleic acid, itaconic acid and/or maleic anhydride. Preferred hydrophilic monomers are, for example, acrylic acid, methacrylic acid, 2-acrylamido-2-methylpropanesulfonic acid, vinylsulfonic acid, maleic anhydride and/or maleic acid.

The hydrophobic monomers can, if appropriate, also be used together with compounds which contain at least two ethylenically unsaturated double bonds, e.g. divinylbenzene, butadiene, ethylene glycol diacrylate, ethylene glycol dimethacrylate, butanediol diacrylate, butanediol dimethacrylate, pentaerythrityl tetraacrylate, pentaerythrityl triallyl ether, methylenebisacrylamide, hexanediol dimethacrylate, trimethylolpropane triacrylate, diallyl ether, triallylamine and/or allyl acrylate. These compounds are known to be used as crosslinking agents in polymerization reactions. In the miniemulsion polymerization, they also lead to crosslinking of the polymers formed from the abovementioned hydrophobic monomers and any hydrophilic monomers used. If crosslinking agents are present, the amount of crosslinking agent is, for example, from 0.001 to 10, preferably from 0.01 to 1, % by weight, based on the monomers used. Depending on solubility, the crosslinking agents can be added to the aqueous or the organic phase all at once, in portions or by the feed procedure. They can also be added to the miniemulsion before or during the polymerization.

A further variation of the properties of the polymers can be achieved by carrying out the miniemulsion polymerization in the presence of regulators. For this purpose, at least one regulator is added all at once, in portions or by the feed procedure, preferably to the organic phase before the emulsification or to the miniemulsion at the beginning of the polymerization or during the polymerization. If regulators are used, the amounts are, for example, from 0.01 to 10, preferably from 0.1 to 2, % by weight, based on the monomers used.

In order to stabilize a miniemulsion, if appropriate a nonpolymerizable hydrophobic compound, e.g. a hydrocarbon, an alcohol of 10 to 24 carbon atoms, a hydrophobic polymer having a molar mass Mw of <10 000, a tetraalkylsilane and/or a mixture of said compounds, is used in the preparation of these emulsions. Examples of such stabilizers are hexadecane, olive oil, polystyrene having a molar mass Mw of from 500 to 5000, siloxanes having a molar mass Mw of from 500 to 5000, cetyl alcohol, stearyl alcohol, palmityl alcohol and/or behenyl alcohol and water-insoluble acrylates and methacrylates, such as lauryl acrylate, lauryl methacrylate, palmityl acrylate, palmityl methacrylate, stearyl acrylate, stearyl methacrylate, behenyl acrylate and/or behenyl methacrylate.

The organic phase, which, for the preparation of the miniemulsions, is emulsified in the aqueous phase, contains, for example, from 45 to 95, preferably from 60 to 80, % by weight of at least one hydrophobic monomer and, if appropriate, other monomers and from 5 to 50, preferably from 10 to 30, % by weight of at least one alkenylsuccinic anhydride. If required, the organic phase may contain from 1 to 10, preferably from 2 to 5, % by weight of a nonpolymerizable hydrophobic compound.

The aqueous phase which is used for the preparation of the miniemulsions comprises water and contains, if appropriate, a surfactant which stabilizes the finely divided monomer droplets formed in the emulsion of the organic phase in the aqueous phase, and, if appropriate, a water-soluble and/or water-swellable polysaccharide. The surfactant is present, for example, in amounts of from 0.05 to 5, preferably from 0.1 to 1, % by weight in the aqueous phase, in the organic phase or in both phases. It is preferably added to the aqueous phase before the emulsification. In principle, all surfactants may be used. Preferably used surfactants are anionic compounds. Examples of suitable surfactants are sodium laurylsulfate, sodium dodecylsulfate, sodium hexadecylsulfate, sodium dioctylsulfosuccinate and/or adducts of from 15 to 50 mol of ethylene oxide with 1 mol of a C₁₂- to C₂₂-alcohol.

In a preferred embodiment of the invention, the organic phase consists of a solution, of a binary or polynary mixture and/or of a dispersion which contains
at least one C₁₄- to C₂₂-alkenylsuccinic anhydride,
at least one monomer from the group consisting of styrene, methylstyrene, C₂- to C₂₈-olefins, esters of monoethylenically unsaturated carboxylic acids of 3 to 5 carbon atoms and monohydric alcohols of 1 to 22 carbon atoms, vinyl esters of C₁- to C₁₈-carboxylic acids, acrylonitrile and methacrylonitrile, and
at least one hydrocarbon, an alcohol of 10 to 24 carbon atoms, hydrophobic polymers having molar masses Mw of <10000, tetraalkylsilanes and/or mixtures of said compounds.

If the monomers are not completely miscible with one another in the presence of ASA, binary, ternary or polynary mixtures or dispersions form and are then emulsified in the aqueous phase. This is the case particularly when the organic phase also contains hydrophilic monomers in addition to hydrophobic ones. A procedure in which the organic phase consists of a solution which contains
at least one C₁₆/C₁₈-alkenylsuccinic anhydride and
styrene, n-butyl acrylate, tert-butyl acrylate and/or acrylonitrile
   is particularly preferred.

As mentioned above, the polymerization can also be carried out in the presence of at least one polysaccharide. The suitable polysaccharides are water-soluble or water-swellable. They are described, for example, in Römpp, Chemie Lexikon 9th Edition, Volume 5, page 3569, or in Houben-Weyl, Methoden der Organischen Chemie, 4th Edition, Volume 14/2 Chapter IV Umwandelung von Cellulose und Stärke by E. Husemann and R. Werner, pages 862-915 and in Ullmanns Encyclopedia of Industrial Chemistry, 6th Edition, Volume 28, page 533 et seq., under Polysaccharides.

For example, all types of starches, e.g. both amylose and amylopectin, natural starches, hydrophobically or hydrophilically modified starches, anionic starches, cationically modified starches, degraded starches, are suitable for preparing the novel aqueous ASA-containing polymer dispersions, it being possible to carry out the starch degradation, for example, oxidatively, thermally, hydrolytically or enzymatically and it being possible for both natural and modified starches to be used as starch for the starch degradation, dextrins and crosslinked, water-soluble starches which are water-swellable are described, for example, in Ullmanns Encyclopedia of Industrial Chemistry, 6th Edition, Volume 33, cf. Starch, pages 735-737. Conventional crosslinking agents for the preparation of such starches are, for example, POCl₃, epichlorohydrin and mixed anhydrides. Further examples of polysaccharides are glycogens, inulins, chitins, chitosans, pectins, water-soluble cellulose derivatives, such as carboxyalkylcelluloses, cellulose sulfate, cellulose phosphoric esters, cellulose formate and hydroxyethylcelluloses, hemicelluloses, such as xylans, mannans, galactans, glycoproteins and mucopolysaccharides.

Natural starches which can be converted, for example, with the aid of a starch digestion into a water-soluble form, cationic starch, preferably cationically modified potato starch, and anionically modified starches, such as oxidized potato starch, are preferably used. Anionically modified starches whose molecular weight has been decreased are particularly preferred. The decrease in the molecular weight of the starches is preferably carried out enzymatically. The average molar mass of the degraded starches is, for example, from 500 to 100 000, preferably from 1000 to 30 000. The degraded starches have, for example, an intrinsic viscosity ηᵢ of from 0.04 to 0.5 dl/g. Such starches are described, for example, in EP-B-0 257 412 and in EP-B-0 276 770. If a starch is used as a protective colloid, for example, from 1 to 9, preferably from 3 to 5, parts by weight of at least one starch are used per part by weight of ASA.

The preparation of the novel ASA-containing polymer dispersions is preferably effected in the presence of a water-soluble and/or water-swellable polysaccharide. It can be initially taken, for example, in an aqueous solution—if appropriate together with at least one polymerization initiator—and heated to a temperature at which the polymerization of the monomers takes place, for example at a temperature of up to 40° C., for example in the temperature range from −20 to +40° C., preferably from 0 to 20° C. The miniemulsion is then added to this solution so that the monomers contained in the miniemulsion polymerize. However, it is also possible to adopt a procedure in which the miniemulsion is prepared in the presence of at least one water-soluble polysaccharide and the miniemulsion is then subjected to the polymerization by heating it to a temperature at which the polymerization initiators contained therein or subsequently added form free radicals. In this embodiment of the novel process, the organic phase contains
at least one alkenylsuccinic anhydride and
at least one monoethylenically unsaturated hydrophobic monomer in dissolved form.

Emulsification is preferably then effected in the presence of a surfactant in an aqueous phase which contains at least one water-soluble and/or water-swellable polysaccharide with the aid of mechanical emulsification apparatuses with formation of a miniemulsion having a particle size of the emulsified organic phase of not more than 500 nm. Thereafter, the monomers of the miniemulsion are polymerized in the presence of at least one polymerization initiator.

The miniemulsion is preferably mixed with an aqueous solution which contains a degraded starch and is polymerized therein. A particularly preferred procedure is one in which the miniemulsion is mixed continuously or in portions with the aqueous solution of a polysaccharide and is polymerized therein. Depending on the polymerization initiators used in each case, the polymerization can be carried out, for example, at up to 40° C. Since the hydrolysis rate of ASA at temperatures above 40° C. in the presence of water is relatively high, it is advisable to carry out the polymerization of the monomers of the miniemulsion at below 40° C., preferably below 30° C. In most cases, polymerization is effected in the temperature range from 0 to 20° C. The polymerization can in principle also be carried out at below 0° C. if the water contained in the system is not frozen, the remaining components do not crystallize and the miniemulsion is stable. The minimum temperature for the polymerization is determined substantially by the freezing point depression of the water which is caused by the components of the aqueous phase and of the miniemulsion which are dissolved therein. For the freezing point depression, it is also possible to add to the aqueous phase salts such as sodium chloride, potassium chloride, magnesium sulfate, magnesium chloride, ammonium sulfate and/or ammonium chloride or organic solvents which likewise result in a freezing point depression of the water, e.g. ethylene glycol, propylene glycol, polyethylene glycol having molar masses of up to 2000, trimethylolpropane and/or glycerol.

In order to prepare the novel polymer dispersions, for example, a procedure is adopted in which the miniemulsion is metered continuously or in portions into an aqueous solution which, if appropriate, contains an emulsifier and a water-soluble and/or water-swellable polysaccharide and, if appropriate, at least one polymerization initiator and has a temperature of, for example, from 0 to 20° C., at a rate such that the temperature of the reaction mixture can be controlled by removing the heat of polymerization by cooling. In the case of relatively small batches, the miniemulsion can also be added all at once to the abovementioned aqueous solution. The temperature of the miniemulsion is expediently adapted to the temperature at which the polymerization is also to be carried out. The addition of the miniemulsion is preferably effected at the rate of progress of the polymerization. The water-soluble polysaccharide used is preferably a degraded starch, in particular a degraded cationic potato starch or a degraded anionic potato starch.

However, the polymerization can also be initiated by adding an initiator to one of the two phases or to both phases in the preparation of the miniemulsion before the emulsification of the organic phase in the aqueous phase. If an initiator is added to the organic phase, initiators which dissolve in the organic phase, e.g. lauroyl peroxide or tert-butyl hydroperoxide, are preferably used. The choice of the initiators depends on the optimum polymerization temperature. However, the addition of initiators to the aqueous phase is preferred. For this purpose, water-soluble initiators, e.g. hydrogen peroxide, or redox systems, preferably comprising hydrogen peroxide and a reducing agent, such as ascorbic acid, isoascorbic acid, acetone-bisulfite adducts or sodium sulfite, are generally used. The amount of initiators which is used in each case in one of the two phases or in both phases is, for example, from 0.05 to 10, preferably from 0.1 to 0.5, % by weight, based on the monomers to be polymerized. Since the polymerization is preferably carried out at relatively low temperatures, redox initiators are preferably used. However, the polymerization can also be initiated with the aid of high-energy radiation, such as UV radiation.

The miniemulsion polymerization can, if appropriate, additionally be carried out in the presence of at least one alkyldiketene. In this procedure, an organic phase which contains
at least one alkenylsuccinic anhydride and at least one alkyldiketene and
at least one monoethylenically unsaturated hydrophobic monomer
   in dissolved form is used as starting material and is emulsified in the presence of a surfactant in an aqueous phase which preferably contains at least one water-soluble polysaccharide with the aid of mechanical emulsification apparatuses with formation of a miniemulsion having a particle size of the emulsified organic phase of not more than 500 nm, and the monomers of the miniemulsion are polymerized in the presence of at least one polymerization initiator. Finely divided alkenylsuccinic anhydrides and alkylketene dimers (AKD) in the form of a polymer matrix dispersed in water are then obtained. Such aqueous polymer dispersions are referred to as ASA/AKD hybrids. They differ from the known ASA emulsions or AKD dispersions stabilized with cationic starch simply on the basis of the particle size of ASA and AKD in the polymer dispersions. The particle size of the alkylketene dimers in the ASA/AKD hybrids is in the range of the particle size of the ASA particles, i.e. from 50 to 500 nm, preferably from 50 to 200 nm.

Alkyldiketenes (AKD) are known compounds which are used in the form of aqueous dispersions as engine sizes for paper. They are prepared, for example, from acyl chlorides by hydrogen chloride elimination with tertiary amines. C₁₄- to C₂₂-Alkyldiketenes are particularly suitable for the sizing of paper. Such compounds are described, for example, in WO-A-96/31650, page 3, lines 31 to 46. Of particular technical interest are, for example, stearyldiketene, oleyldiketene, palmityldiketene and behenyldiketene. If appropriate, the novel polymer dispersions contain, for example, from 0.01 to 100, preferably from 0.1 to 1.0, parts by weight of at least one alkyldiketene per part by weight of ASA.

The water-soluble and/or water-swellable polysaccharides are contained in the novel ASA-containing aqueous polymer dispersions in amounts of, for example, from 10 to 50, preferably from 15 to 35, % by weight. The novel dispersions have a polymer content of preferably from 20 to 60, in particular from 20 to 40, % by weight and contain from 5 to 50% by weight of at least one alkenylsuccinic anhydride. The particle size of the dispersed polymers and of the emulsified alkenylsuccinic anhydrides in the novel dispersions is, for example, from 50 to 500 nm, preferably from 50 to 200 nm, and is generally from 50 to 100 nm.

The novel ASA-containing dispersions are used as sizes for paper and as water repellents for leather, natural and/or synthetic fibers and textiles. They can be used both in the engine sizing of paper and in the surface sizing of paper. In each case the process chemicals customary in papermaking, such as strength agents, retention aids, drainage aids, bactericides and/or dyes, may be present here in the conventional amounts. The novel dispersions can be used for sizing all paper grades and paper products, such as cardboard and board. For the sizing of paper and paper products, the ASA-containing dispersions are used, for example, in amounts of from 0.03 to 3.0, preferably from 0.2 to 1.0, % by weight, based on the solids content of the dispersion and dry paper stock.

A typical application for the novel dispersions is the surface sizing of paper and paper products. In the surface sizing, the amounts of the ASA-containing polymer dispersions used are, for example, from 0.03 to 3, preferably from 0.2 to 1.0, % by weight, based on the solids content of the dispersion and dry paper. Compared with the papers which were sized only with conventional alkyldiketene dispersions, the papers sized therewith have the advantage that they possess excellent adhesion for toners on papers which are used for the production of copies in copiers. Since toners adhere excellently to these papers, they can also advantageously be used in laser printers.

Unless otherwise evident from the context, the stated percentages in the examples are by weight. The particle sizes were measured using a Coulter N4 Plus laser diffraction apparatus or alternatively using a Coulter 230 LS.

### EXAMPLE

### Preparation of a Miniemulsion

A solution of 4.8 g of hexadecane, 32 g of a C₁₆/C₁₈-alkenylsuccinic anhydride in 64 g of styrene and 64 g of n-butyl acrylate was added to a solution of 3.2 g of acrylic acid, 21.4 g of a 15% strength aqueous sodium laurylsulfate solution in 347.1 g of demineralized water. This two-phase mixture was then emulsified twice at 300 bar using an APV-Gaulin high-pressure homogenizer at not more than 25° C., the pH being about 3.5. The mean drop diameter of the miniemulsion was 138 nm (measured using a Coulter N4 Plus apparatus). The polydispersity index was 0.11. This emulsion was then used immediately for the preparation of the dispersion.

### Preparation of an ASA-Containing Polymer Dispersion

222 g of maltodextrin 019S1 (15% strength in water),
1 g of a 40% strength aqueous solution of a complex of an iron(II) salt with ethylenediaminetetraacetic acid,
6 g of tert-butyl hydroperoxide (70% strength in water) and
3.7 g of a 5% strength aqueous solution of Rongalit® C (adduct of formaldehyde with sodium dithionite)
   were initially taken in a reactor which was stirred at 150 rpm, had a capacity of 2 l and was flushed with nitrogen, and the reaction mixture was cooled to 10° C. After 5 minutes, the miniemulsion described above (feed 1) and 69.5 g of a 5% strength aqueous solution of Rongalit C (feed 2) were metered simultaneously, with the proviso that feed 1 was added after 15.5 hours and feed 2 after 16 hours, the first 2.7 g of the miniemulsion being metered in 10 minutes, the next 5.4 g of the miniemulsion in a further 10 minutes and 8.1 g of the miniemulsion likewise in 10 minutes. The remainder of the miniemulsion (520.3 g) was then metered in the course of 15 hours. During the polymerization, the temperature of the reaction mixture was kept in the range of 11-12° C.

A sample of the batch showed that the nonvolatile fractions were 19.7%, corresponding to a conversion of >85%. The mean particle size of the polymer dispersion was 127 nm. For completion of the polymerization, 4 g of 10% strength aqueous tert-butyl hydroperoxide were then added at 11-12° C. The temperature increased by about 1° C. during this procedure. The peroxide test was negative after a short time.

½ hour after the peroxide addition, a dispersion having a solids content of 23% and a mean particle size of 127 nm was obtained. 820 g of a finely divided dispersion were obtained by filtration over a 125 μm filter, on which no residue was found.

The dispersion was tested as an engine size and as a surface size for paper. Sized papers which had a good degree of sizing and permitted satisfactory writing with ink and printing were obtained. Compared with the conventional C₁₆/C₁₈-alkenylsuccinic anhydride sizes, the novel dispersions have a greatly improved storage stability. For example, in contrast to the known C₁₆/C₁₈-alkenylsuccinic anhydride dispersions, the novel dispersions still had sizing activity even after storage for 12 hours at 40° C.

1: An aqueous alkenylsuccinic anhydride-containing polymer dispersion which is obtainable by miniemulsion polymerization of hydrophobic monoethylenically unsaturated monomers in the presence of alkenylsuccinic anhydrides.

2: An aqueous alkenylsuccinic anhydride-containing polymer dispersion according to claim 1, which is obtainable by emulsifying an organic phase which contains
at least one alkenylsuccinic anhydride and
at least one monoethylenically unsaturated hydrophobic monomer
in dissolved form, in the presence of a surfactant in an aqueous phase with the aid of mechanical emulsification methods with formation of a miniemulsion having a particle size of the emulsified organic phase of not more than 500 nm, at least one of the two phases additionally containing a free radical polymerization initiator, or a polymerization initiator being added to the miniemulsion, and polymerizing the monomers of the miniemulsion.

3: An aqueous alkenylsuccinic anhydride-containing polymer dispersion according to claim 1, which is obtainable by emulsifying the organic phase in the aqueous phase to give a miniemulsion by the action of ultrasound or with the aid of high-pressure homogenizers.

4: An aqueous alkenylsuccinic anhydride-containing polymer dispersion according to claim 1, wherein the organic phase additionally contains a nonpolymerizable hydrophobic compound.

5: An aqueous alkenylsuccinic anhydride-containing polymer dispersion according to claim 1, wherein the organic phase consists of a solution, of a binary or polynary mixture and/or of a dispersion which contains
at least one C₁₄- to C₂₂-alkenylsuccinic anhydride,
at least one monomer from the group consisting of styrene, methylstyrene, C₂- to C₂₈-olefins, esters of monoethylenically unsaturated carboxylic acids of 3 to 5 carbon atoms and monohydric alcohols of 1 to 22 carbon atoms, vinyl esters of C₁- to C₁₈-carboxylic acids, acrylonitrile and methacrylonitrile, and
at least one hydrocarbon, an alcohol of 10 to 24 carbon atoms, hydrophobic polymers having molar masses Mw of <10 000, tetraalkylsilanes and/or mixtures of said compounds.

6: An aqueous alkenylsuccinic anhydride-containing polymer dispersion according to claim 1, wherein the miniemulsion polymerization is additionally carried out in the presence of at least one water-soluble and/or water-swellable polysaccharide.

7: An aqueous alkenylsuccinic anhydride-containing polymer dispersion according to claim 1, wherein the miniemulsion polymerization is additionally carried out in the presence of at least one alkyldiketene.

8: A process for the preparation of aqueous alkenylsuccinic anhydride-containing polymer dispersions, wherein the hydrophobic monomers are polymerized by a miniemulsion polymerization method in the presence of at least one alkenylsuccinic anhydride.

9: A process according to claim 8, wherein the miniemulsion polymerization is additionally carried out in the presence of at least one water-soluble and/or water-swellable polysaccharide.

10: A process for the preparation of aqueous alkenylsuccinic anhydride-containing polymer dispersions according to claim 8, wherein an organic phase which contains
at least one alkenylsuccinic anhydride and
at least one monoethylenically unsaturated hydrophobic monomer
in dissolved form is emulsified in the presence of a surfactant in an aqueous phase with the aid of mechanical emulsification apparatuses with formation of a miniemulsion having a particle size of the emulsified organic phase of not more than 500 nm, and the monomers of the miniemulsion are polymerized in the presence of at least one water-soluble and/or water-swellable polysaccharide and at least one polymerization initiator.

11: A process according to claim 9, wherein the miniemulsion is mixed with an aqueous solution which contains a water-soluble starch, and the mixture is polymerized in the presence of at least one polymerization initiator at up to 40° C.

12: A process according to claim 8, wherein the miniemulsion is mixed with an aqueous solution which contains a degraded starch in dissolved form.

13: A process according to claim 8, wherein the miniemulsion is polymerized continuously or batchwise in the presence of a water-soluble and/or water-swellable polysaccharide.

14: A process according to claim 8, wherein the polymerization is carried out at from −20 to 40° C.

15: A process according to claim 8, wherein the miniemulsion polymerization is additionally carried out in the presence of an alkyldiketene.

16: A process according to any of claim 8, wherein an organic phase which contains
at least one alkenylsuccinic anhydride and at least one alkyldiketene and
at least one monoethylenically unsaturated hydrophobic monomer
in dissolved form is emulsified in the presence of a surfactant in an aqueous phase which contains at least one water-soluble polysaccharide with the aid of mechanical emulsification apparatuses with formation of a miniemulsion having a particle size of the emulsified organic phase of not more than 500 nm, and the monomers of the miniemulsion are polymerized in the presence of at least one polymerization initiator.

17: A process according to claim 16, wherein the water-soluble polysaccharide used is a degraded starch.

18: The method of using as an engine size and surface size for paper and for imparting water repellency to leather, natural and/or synthetic fibers and textiles an aqueous alkenylsuccinic anhydride-containing polymer dispersion according to claim 1.
